(19) United States
(12) Patent Application Publication
(10) Pub. No.: US 2005/0211182 A1
(43) Pub. Date: Sep. 29, 2005

(54) Collector of animal debris and method

(76) Inventor: James R. Sage JR., Cyclone, PA (US)

Correspondence Address: Ansel M. Schwartz, Suite 304, 201 N. Craig Street, Pittsburgh, PA, 15213, US

(21) Appl. No.: 10/800,910

(22) Filed: Mar. 15, 2004

(51) Int. Cl. A01K 29/00

(52) U.S. Cl. 119/621; 119/600

(57) ABSTRACT

A collector of debris from an animal's paw includes a tray. The collector includes a grid which fits in the tray upon which the animal steps and causes debris on the animal's paw to be dislodged from the paw and fall through the grid on to the tray. The grid formed of channels having a rounded surface. A method for collecting debris from an animal's paw.

### FIELD OF THE INVENTION

The present invention is related to a collector of debris from an animal's paw. More specifically, the present invention is related to a collector of debris from an animal's paw having a grid formed of channels having a rounded surface.

### BACKGROUND OF THE INVENTION

It is a common experience with animals, such as cats, that when they leave a litter box, debris such as the litter in the litter box, collects on their paws and is tracked by the animal onto the floor about the litter box. To attempt to prevent debris from being scattered by the animal after leaving the litter box, debris collectors are placed in front of the door or exit way of the litter box for the cat to step on and catch the debris or cause the debris to come off of the paw on the cat. These debris collectors, such as in U.S. Pat. No. 5,816,195, have a grid that have a surface that is formed by edges that are generally sharp to the feel of the paw of the cat. This discomfort to the cat results in the cat many times jumping from the litter box over the debris collector, to avoid having to contact the sharp edges of the surface of the grid of the debris collector, thus defeating the purpose of the debris collector. The present invention provides for a grid that has rounded surfaces that do not cause discomfort to the animal when the animal steps on the rounded surface.

### SUMMARY OF THE INVENTION

The present invention pertains to a collector of debris from an animal's paw. The collector comprises a tray. The collector comprises a grid which fits in the tray upon which the animal steps and causes debris on the animal's paw to be dislodged from the paw and fall through the grid on to the tray, the grid formed of channels having a rounded surface.

The present invention pertains to a method for collecting debris from an animal's paw. The method comprises the steps of placing a debris collector at a desired location, the collector comprises a tray. The collector comprises a grid which fits in the tray upon which the animal steps and causes debris on the animal's paw to be dislodged from the paw and fall through the grid on to the tray, the grid formed of channels having a rounded surface. There is the step of collecting debris from the animal's paw in the tray as the paw contacts the channels of the grid.

### BRIEF DESCRIPTION OF THE DRAWINGS

In the accompanying drawings, the preferred embodiment of the invention and preferred methods of practicing the invention are illustrated in which:

FIG. 1 is an exploded view of a collector of the present invention.

FIG. 2 is an overhead view of the tray.

FIG. 3 is an overhead view of the grid.

FIG. 4 is an overhead view of the grid in the tray.

FIG. 5 is a perspective view of an animal leaving a litter box and stepping on the collector.

FIG. 6 is a cross-sectional view of a portion of the grid in the tray.

FIG. 7 is a cross-sectional view of a support of the grid in the tray.

FIG. 8 is an overhead view of the grid in the tray.

FIG. 9 is a sectional view of FIG. 8.

### DETAILED DESCRIPTION

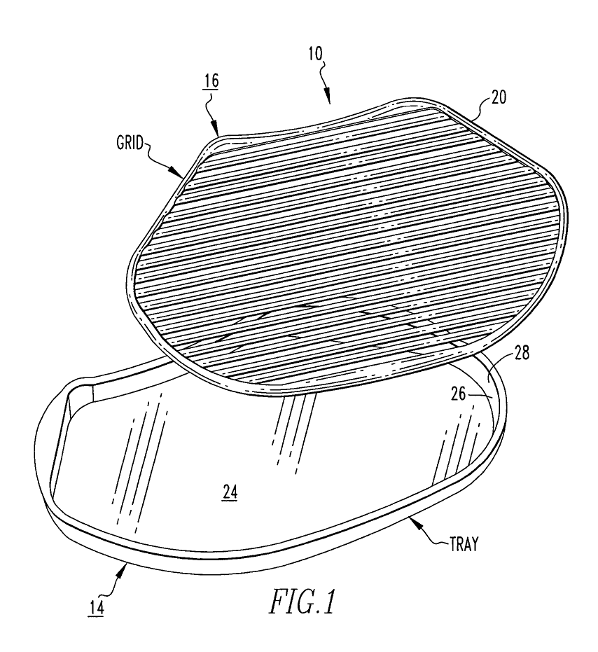

Referring now to the drawings wherein like reference numerals refer to similar or identical parts throughout the several views, and more specifically to FIG. 1 thereof, there is shown a collector 10 of debris 18 from an animal's paw 12. The collector 10 comprises a tray 14. The collector 10 comprises a grid 16 which fits in the tray 14 upon which the animal steps and causes debris 18 on the animal's paw 12 to be dislodged from the paw 12 and fall through the grid 16 on to the tray 14, the grid 16 formed of channels 20 having a rounded surface 22.

Preferably, the channels 20 are in spaced relation with each other. The channels 20 preferably have a space 36 between 1/16 inch and 1/2 inch. Preferably, the channels 20 are in parallel with each other.

The tray 14 preferably has a base 24 with a perimeter 26 and a wall 28 that extends along and from the base 24. The grid 16 fits within the wall 28 and on the base 24. Preferably, the grid 16 has a stand 30 to which the channels 20 are connected that support the channels 20 above the base 24 and in spaced relation to the base 24.

The present invention pertains to a method for collecting debris 18 from an animal's paw 12. The method comprises the steps of placing a debris 18 collector 10 at a desired location, the collector 10 comprises a tray 14. The collector 10 comprises a grid 16 which fits in the tray 14 upon which the animal steps and causes debris 18 on the animal's paw 12 to be dislodged from the paw 12 and fall through the grid 16 on to the tray 14, the grid 16 formed of channels 20 having a rounded surface 22. There is the step of collecting debris 18 from the animal's paw 12 in the tray 14 as the paw 12 contacts the channels 20 of the grid 16.

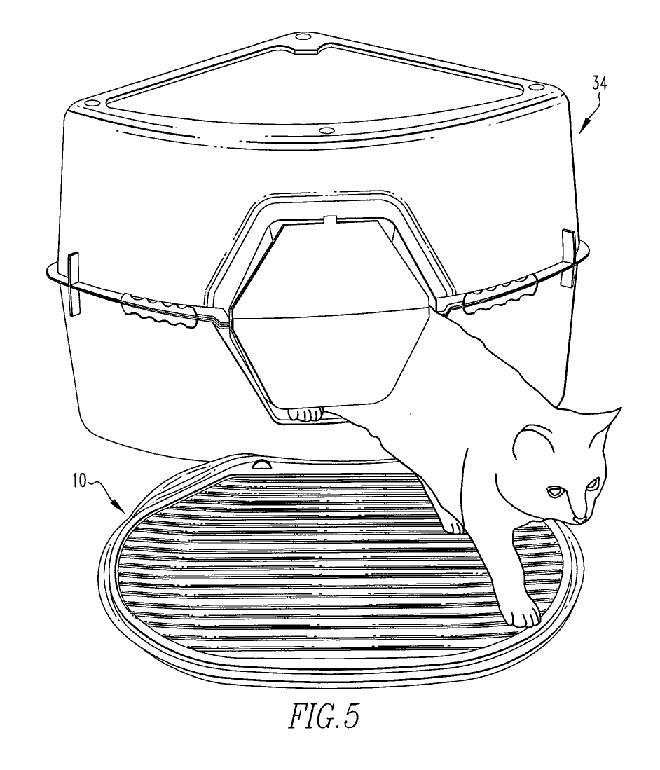

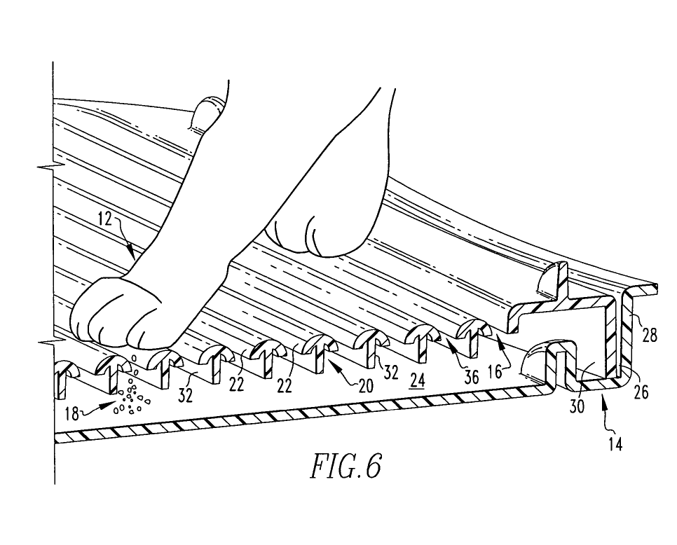

In the operation of the invention and as shown in FIG. 5, the cat leaves a litter box 34 and steps on the collector 10. Any debris 18 that has collected on the paw 12 of the cat is rubbed off or falls off when the paw 12 of the cat strikes the channels 20 of the grid 16 of the collector 10. As shown in FIG. 6, the space 36 between the channels 20 allows the debris 18 to fall through the channels 20 and drop onto the base 24 of the tray 14. The channels 20 have a rounded surface 22 so they do not cause discomfort to the cat when the paw 12 contacts the surface 22. The channels 20 are in parallel so they effectively form a floor with just enough space in between to allow the debris 18 to fall through the channels 20.

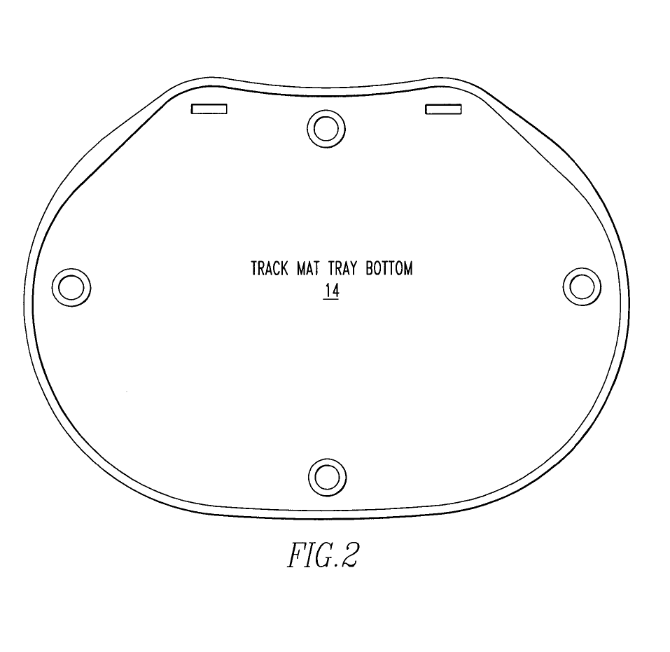

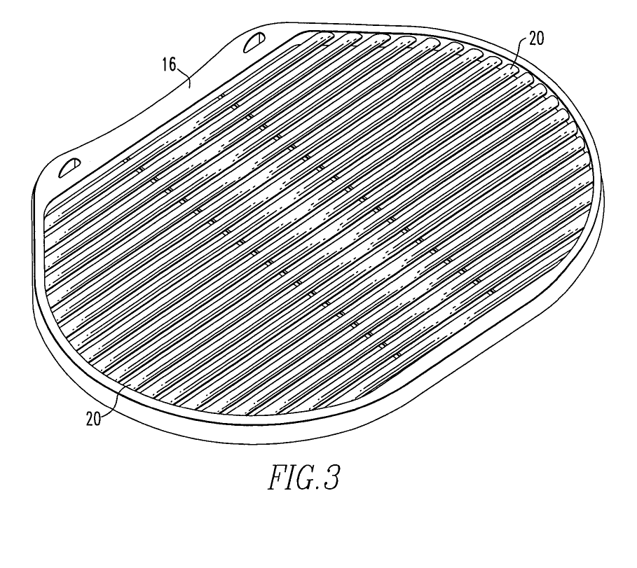

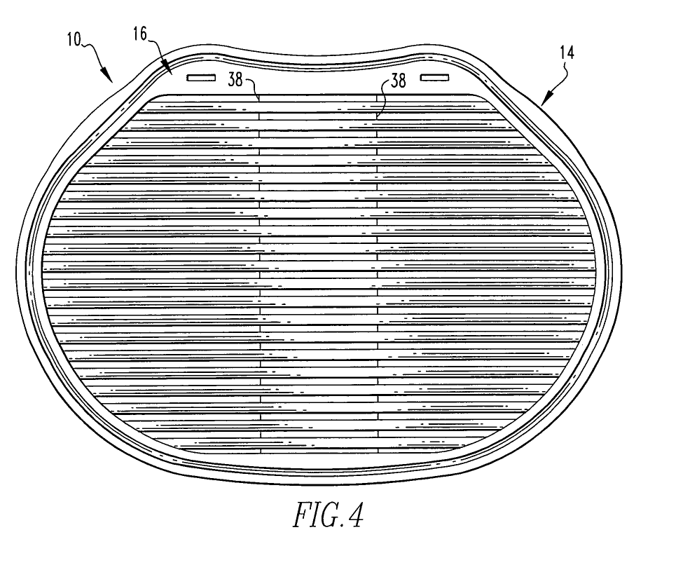

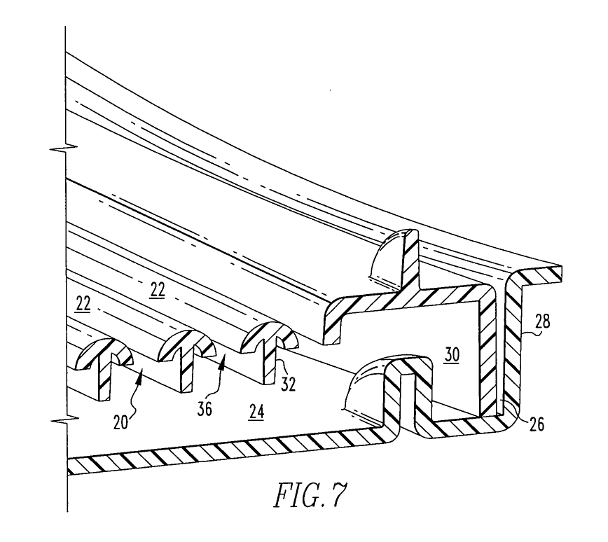

The grid 16 fits into the tray 14 and is held in place by a wall 28 of the tray 14 that extends around and up from the perimeter 26 of the tray 14, as shown in FIGS. 1-4. When the tray 14 needs to be emptied of the debris 18 that has collected in it, the grid 16 is lifted, and the tray 14 is just turned over so the debris 18 can fall into the waste container. The perimeter 26 of the grid 16 has a stand 30, as shown in FIG. 7, to which the channels 20 connect and which holds the channels 20 above the base 24 of the tray 14. Under each channel 20 is a leg 32 that provides structural integrity so the channel 20 does not buckle under the weight of the cat as the cat steps on the channel. There are also two bands 38 which extended across the channels 20 in a perpendicular direction to the direction of the channels 20 to provide further structural integrity to the channels 20.

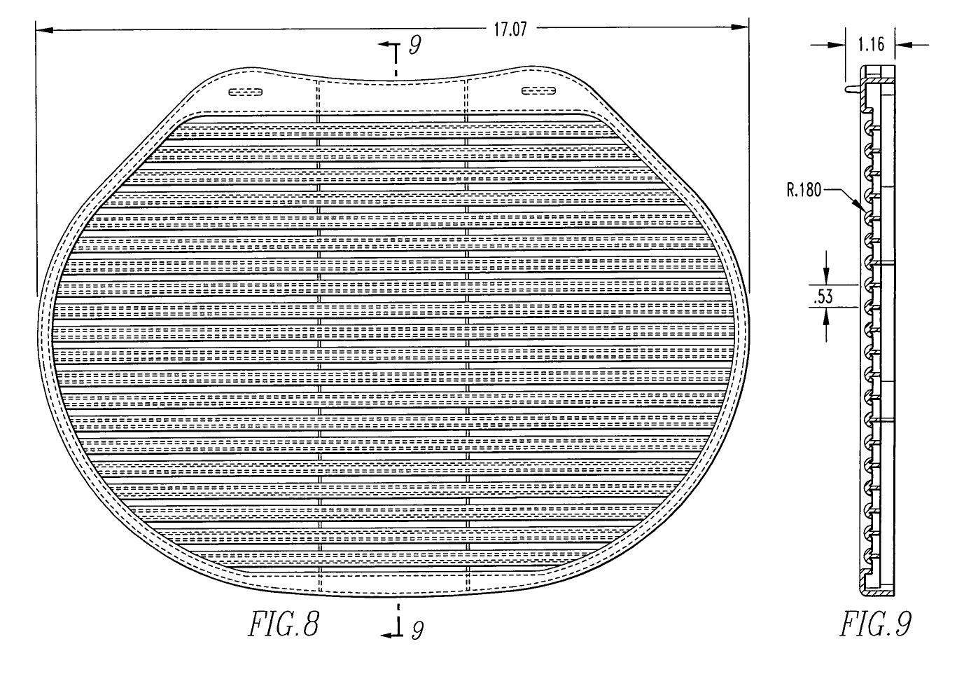

The space 36 between each channel 20 is preferably 3/16 inches, with the overall dimensions of the collector 10 being 18 in. wide, 13 in. long, 7/8 inches tall in the front and 1.5 in. tall at the tallest point of the tray 14 handles in the back. The grid 16 is 17 in. wide, 12⅜ inches from front to back and is 13/16 inches tall with the finger tabs 3/8 inches high. The radius of curvature of the surface 22 is preferably between 0.1 and 0.3 inches and more preferably 0.180 inches, with a pitch preferably between 0.3 and 0.8 inches and more preferably 0.53 inches, as shown in FIGS. 8 and 9.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A collector of debris from an animal's paw comprising:
a tray; and
a grid which fits in the tray upon which the animal steps and causes debris on the animal's paw to be dislodged from the paw and fall through the grid on to the tray, the grid formed of channels having a rounded surface, the grid removable from the tray so the tray can be turned over and debris emptied from the tray.

2. A collector as described in claim 1 wherein the channels are in spaced relation with each other.

3. A collector as described in claim 2 wherein the channels have a space between 1/16 inch and 1/2 inch.

4. A collector as described in claim 3 wherein the channels are in parallel with each other.

5. A collector as described in claim 4 wherein the tray has a base with a perimeter and a wall that extends along and from the base, the grid fits within the wall and on the base.

6. A collector as described in claim 5 wherein the grid has a stand to which the channels are connected that support the channels above the base and in spaced relation to the base.

7. A method for collecting debris from an animal's paw comprising the steps of:
placing a debris collector at a desired location, the collector comprising a tray, and a grid which fits in the tray upon which the animal steps and causes debris on the animal's paw to be dislodged from the paw and fall through the grid on to the tray, the grid formed of channels having a rounded surface;
collecting debris from the animal's paw in the tray as the paw contacts the channels of the grid;
lifting the grid from the tray; and
turning over the tray so the debris empties from the tray.
